(19) United States
(12) Patent Application Publication
(10) Pub. No.: US 2005/0243721 A1
(43) Pub. Date: Nov. 3, 2005

(54) Method and apparatus for controlling access to a multimedia broadcast/multicast service

(76) Inventors: Zhijun Cai, N. Richland Hills, TX (US); Bonnie Chen, DeSoto, TX (US)

Correspondence Address: MOTOROLA, INC., 1303 EAST ALGONQUIN ROAD, IL01/3RD, SCHAUMBURG, IL, 60196, US

(21) Appl. No.: 11/113,628

(22) Filed: Apr. 25, 2005

Related U.S. Application Data
(60) Provisional application No. 60/566,275, filed on Apr. 29, 2004.

(51) Int. Cl. H04L 12/26

(52) U.S. Cl. 370/230; 370/278

(57) ABSTRACT

A Multimedia Broadcast/Multicast Service (MBMS) application server in a packet data communication system produces multiple access control parameters that at least partially identify a storage location of MBMS data and that define when a user equipment may access the stored MBMS data. The multiple access control parameters are then distributed to user equipment (UE) subscribed to the MBMS service. When a subscribed UE fails to receive, or erroneously receives, MBMS data associated with the MBMS service, the subscribed UE uses the distributed access control parameters to determine when and where to access the stored MBMS data.

### CROSS-REFERENCE TO RELATED APPLICATION

This application claims priority from provisional application Ser. No. 60/566,275, entitled “METHOD AND APPARATUS FOR CONTROLLING ACCESS TO A MULTIMEDIA BROADCAST/MULTICAST SERVICE,” filed Apr. 29, 2004, which is commonly owned and incorporated herein by reference in its entirety.

### FIELD OF THE INVENTION

The present invention relates generally to packet data communication systems, and, in particular, to a multimedia broadcast multicast service in a packet data communication system.

### BACKGROUND OF THE INVENTION

The Universal Mobile Telecommunication Service (UMTS) standard provides a compatibility standard for cellular mobile telecommunications systems. The UMTS standard ensures that a mobile station (MS), or user equipment (UE), operating in a UMTS system can obtain communication services when operating in a system manufactured according to the standard. To ensure compatibility, radio system parameters and data transfer procedures are specified by the standard, including protocols governing digital control messages and bearer traffic that are exchanged over an air interface.

The UMTS standards provide, in 3GPP TS 25.344 (Third Generation Partnership Project Technical Specification 25.344) v0.5.0, 3GPP TS 23.246 6.2.0, and 3GPP TS 23.846 v6.1.0, for a provision of a Multimedia Broadcast/Multicast Service (MBMS) by a UMTS communication system to user equipment (UEs) serviced by the system and subscribed to the service. When a user equipment (UE) activates in a communication system that provides an MBMS service, for example, a broadcast of audio, video, and/or data concerning a sporting event such as a Super Bowl or a World Cup soccer game, the UE may register for the MBMS service by indicating to the communication system a willingness to receive multicast data associated with the MBMS service. By registering for the MBMS service, the UE joins a multicast group associated with the MBMS service.

When the MBMS service begins, that is, when the communication system receives MBMS data for conveyance to subscribers to the service, a Radio Network Controller (RNC) included in a Radio Access Network (RAN) of a UMTS infrastructure determines whether to establish a Point-To-Multipoint (PTM) communication channel in a cell or a Point-To-Point (PTP) communication channel to each UE in the cell. The RNC then broadcasts a MBMS notification via a Node B included in the RAN, typically a base transceiver station (BTS), and a control channel to all UEs in the cell. The notification typically includes an identifier associated with the MBMS service. In response to receiving the MBMS notification, each UE in the cell that subscribes to the MBMS service conveys a connection request, typically a Radio Resource Control (RRC) connection establishment request, to the RNC via an access channel. Upon receiving the connection requests from each subscribed UE, the RNC sets up a communication session by establishing a PTM communication channel or PTP communication channels with the responding UEs, whichever the RNC has determined to establish, and conveys the MBMS data to the subscribed UEs over the established channel or channels.

It has been proposed that a subscribed UE be able to retrieve missing, or unacceptably received, data from a network element, in particular a User Support Server, that maintains a copy of the data when a subscribed UE fails to acceptably receive a portion of the MBMS data or the MBMS data in its entirety. For example, it has been proposed that a Session Identifier (Session ID) or a Sequence Identifier (Sequence ID) be embedded in data packets associated with each communication session of multiple communication sessions that may be part of provision of an MBMS service. When a user misses or fails to acceptably received data packets associated with a communication session of the multiple sessions, the user is able to determine the Session ID or Sequence ID associated with the missing data and convey the Session or Sequence ID to the network element maintaining the data. In response to receiving the Session or Sequence ID, the network element maintaining the data may then convey the data associated with the Session or Sequence ID to the user.

However, the UMTS standards fail to specify how to inform the subscribed UEs where the MBMS data may be retrieved after the service has been provided. In addition, the UMTS standards fail to specify how to control access to the storage location of the MBMS data when a significant number of subscribers attempt to access the system at overlapping times in order to retrieve stored MBMS data after they fail to receive, or unacceptably receive, the MBMS data during the provision of the MBMS service. For example, marginal or bad channel conditions may cause multiple UEs to concurrently, unacceptably receive MBMS data. As opposed to typical attempts to access a wireless infrastructure, with respect to an MBMS service subscribed UEs cannot be denied access to the stored data. As a result, excessive system congestion may result and uplink communication links may become overloaded, not merely between the subscribers and the RAN but also between all elements of the RAN linking the subscribers to the network element maintaining the MBMS data.

Therefore, a need exists for a method and apparatus that informs UEs subscribed to an MBMS service where data associated with the service may be retrieved and that further controls access to the storage location of the MBMS data so that overloading of the system is avoided but that allows all subscribed UEs to access the MBMS data.

### BRIEF DESCRIPTION OF THE DRAWINGS

FIG. 1 is a block diagram of a wireless communication system in accordance with an embodiment of the present invention.

FIG. 2 is logic flow diagram of a method by which the communication system of FIG. 1 produces multiple access control parameters and distributes the multiple access control parameters in accordance with an embodiment of the present invention.

FIG. 3 is a logic flow diagram of a method by which the user equipment of FIG. 1 determines when to access the infrastructure of FIG. 1 to retrieve missing or erroneously received Multimedia Broadcast/Multicast Service data in accordance with an embodiment of the present invention.

FIG. 4 is a logic flow diagram of a method by which the user equipment of FIG. 1 determines when to access the infrastructure of FIG. 1 to retrieve missing or erroneously received Multimedia Broadcast/Multicast Service data in accordance with another embodiment of the present invention.

### DETAILED DESCRIPTION OF THE INVENTION

To address the need for a method and an apparatus that that informs user equipment (UEs) subscribed to a Multimedia Broadcast/Multicast Service (MBMS) service where data associated with the service may be retrieved and that further controls access to the storage location of the MBMS data so that overloading of the system is avoided but that allows all subscribed UEs to access the MBMS data, an MBMS application server in a packet data communication system produces multiple access control parameters that at least partially identify a storage location of MBMS data and define when a user equipment may access the stored MBMS data. The multiple access control parameters are then distributed to user equipment (UE) subscribed to the MBMS service. When a subscribed UE fails to receive, or erroneously receives, MBMS data associated with the MBMS service, the subscribed UE uses the distributed access control parameters to determine when and where to access the stored MBMS data.

Generally, an embodiment of the present invention encompasses a method for controlling access to MBMS data. The method includes receiving a request to participate in an MBMS service, in response to receiving the request, producing multiple access control parameters comprising a first access control parameter that identifies a storage location of MBMS data and a second access control parameter that defines when a user equipment may access the stored MBMS data; and conveying the multiple access control parameters to a source of the received request.

Another embodiment of the present invention encompasses a method for accessing stored MBMS data. The method includes storing a first access control parameter that identifies a storage location of the MBMS data and storing a second access control parameter that defines when a subscriber to the MBMS service may attempt to access the stored MBMS data. The method further includes determining at least one of that MBMS data is missing or that received MBMS data has been erroneously received and determining an access time for attempting to access the stored MBMS data based on the received second access control parameter.

Yet another embodiment of the present invention encompasses an MBMS applications server having a processor that receives a request to participate in an MBMS service, in response to receiving the request, produces a multiple access control parameters comprising a first access control parameter that identifies a storage location of MBMS data associated with an MBMS service and a second access control parameter that defines when a subscriber to the MBMS service may attempt to access the stored MBMS data, and conveys the multiple access control parameters to a source of the received request.

Still another embodiment of the present invention encompasses a user equipment including at least one memory device and a processor operably coupled to the at least one memory device. The processor receives a first access control parameter that identifies a storage location of Multimedia Broadcast/Multicast Service (MBMS) data associated with an MBMS service and a second access control parameter that defines when a subscriber to the MBMS service may attempt to access the stored MBMS data. The processor further stores the first access control parameter and the second access control parameter in the at least one memory device, determines at least one of that MBMS data is missing or that received MBMS data has been erroneously received, and determines an access time for attempting to access the stored MBMS data based on the received second access control parameter.

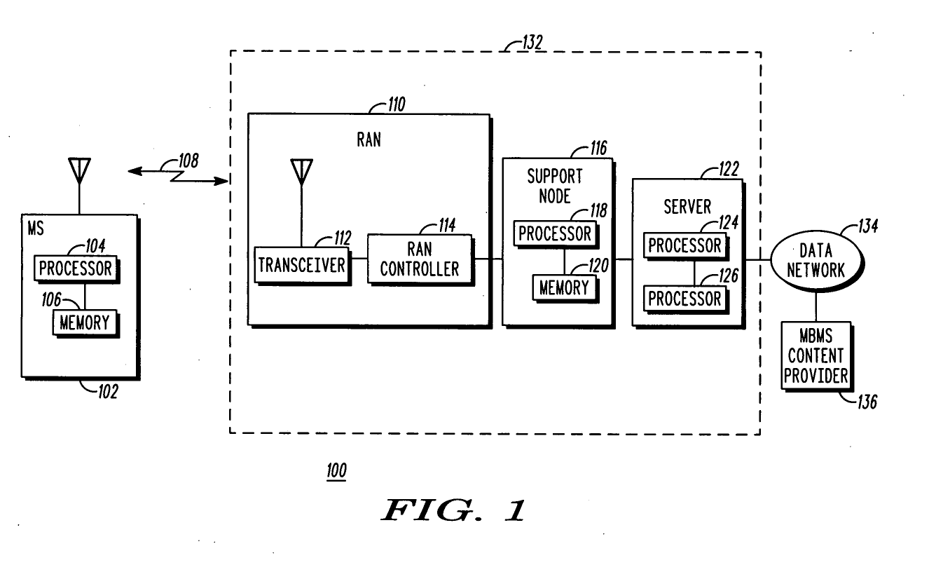

The present invention may be more fully described with reference to FIGS. 1-4. FIG. 1 is a block diagram of a wireless communication system 100 in accordance with an embodiment of the present invention. Communication system 100 includes at least one user equipment (UE) 102, such as but not limited to a cellular telephone, a radio telephone, a personal digital assistant (PDA) with radio frequency (RF) capabilities, or a wireless modem that provides RF access to digital terminal equipment (DTE) such as a laptop computer, in wireless communication with a Radio Access Network (RAN) 110. RAN 110 includes at least one transceiver, or Node B, 112 that is operably coupled to a RAN controller 114, preferably a Radio Network Controller (RNC). Communication system 100 further includes a support node 116 coupled to RAN 110 and a Multimedia Broadcast/Multicast Service (MBMS) application server 122 in communication with RAN controller 114 via the support node.

Support node 116 includes one or more Serving 3G-GPRS Support Nodes (SGSNs) that are each coupled to one or more Gateway 3G-GPRS Support Nodes (GGSNs). MBMS application server 122 includes a Broadcast Multicast Service Center (BM-SC) and may further include other servers, such as a User Support Server, associated with data storage, control, and billing in association with provision of an MBMS service when such functions are not performed by the BM-SC. The precise architecture of support node 116 and server 122 is up to an operator of communication system 100 and is not critical to the present invention. Together, RAN 110, support node 116, and server 122 are collectively referred to herein as a wireless infrastructure 132.

UE 102 is capable of receiving and displaying audio, video, and/or data associated with an MBMS service provided by communication system 100, which service provides for a distribution of MBMS data to UEs subscribed to the MBMS service. MBMS services are described in detail in the 3GPP (Third Generation Partnership Project) standards, and in particular 3GPP TS (Technical Specification) 25.344 v0.5.0, 3GPP TS 23.846 v6.1.0, 3GPP TS 22.146 v6.3.0, 3GPP TS 23.246 v6.2.0, 3GPP TR (Technical Report) 21.905 v6.5.0, and Report R2-030063, which specifications and reports are hereby incorporated by reference herein and copies of which may be obtained from the 3GPP via the Internet or from the 3GPP Organization Partners' Publications Offices at Mobile Competence Centre 650, route des Lucioles, 06921 Sophia-Antipolis Cedex, France.

RAN 110 provides communications services to user equipment, such as UE 102, located in a coverage area, such as a cell, serviced by the RAN via an air interface 108. Air interface 108 comprises a downlink and an uplink that each includes multiple communication channels. The downlink preferably includes a paging channel, at least one downlink control channel, and at least one downlink traffic channel. The uplink preferably includes an uplink access channel, at least one uplink control channel, and at least one uplink traffic channel.

Communication system 100 further includes a Multimedia Broadcast/Multicast Service (MBMS) content provider 136, such as an IP multicast server, that is coupled to infrastructure 132, and in particular to server 122, via a data network 134, such as an IP network. As part of an MBMS service provided by communication system 100 and that may be subscribed to by UE 102, MBMS content provider 136 sources MBMS data, typically in the form of IP data packets, to subscribed UEs, such as UE 102, via server 122, support node 116, and RAN 110.

Each of UE 102, support node 116, and server 122 includes a respective processor 104, 118, 124, such as one or more microprocessors, microcontrollers, digital signal processors (DSPs), combinations thereof or such other devices known to those having ordinary skill in the art. Each of UE 102, support node 116, and server 122 further includes a respective at least one memory device 106, 120, 126 associated with the respective processor, such as random access memory (RAM), dynamic random access memory (DRAM), and/or read only memory (ROM) or equivalents thereof, that store data and programs that may be executed by the processor and allow the processor to operate in communication system 100. Unless otherwise specified herein, all functions described as being performed herein by UE 102, support node 116, or server 122 are performed by the respective processor 104, 118, and 124 of the UE, support node and server.

The at least one memory device 126 of server 122 may further maintain multiple access control parameters that control when and where each subscriber to the MBMS service, such as UE 102, may retrieve associated, stored MBMS data during or after provision of the MBMS service. A first access control parameter of the multiple access control parameters comprises an identifier of a storage location of the MBMS data, such as a routing address, for example, an Internet Protocol (IP) address, that identifies a server storing the MBMS data. A second access control parameter of the multiple access control parameters defines when UEs subscribed to the MBMS service, such as UE 102, may access the stored data.

In one embodiment of the present invention, the second access control parameter may include an access time window (ATW) parameter that identifies an expiration of a time period, or window, during which the subscribed UEs may attempt to access the stored data. In another embodiment of the present invention, the second access control parameter may include at least one access start time (UEAST) parameter that identifies a time at which a subscribed UE may attempt to access the stored data. For example, server 122 may maintain multiple, different access start time (UEAST) parameters, wherein each different UEAST parameter may be allocated to a different subscribed UE and identifies a different time at which the subscribed UE may attempt to access the stored data. By staggering, or in any way spreading out, the UEAST parameters that may be allocated to UEs subscribed to the MBMS service, communication system 100 is able to minimize congestion that may result when multiple subscribed UEs each attempts to access the stored data. The multiple access control parameters stored by server 122 may be programmed into the server by an operator network management of infrastructure 132, or one or more of the multiple access control parameters may be determined on an MBMS service-by-MBMS service basis by processor 124 of server 122.

Preferably, communication system 100 is a Universal Mobile Telecommunication Service (UMTS) communication system that operates in accordance with the 3GPP (Third Generation Partnership Project) standards, which provide a compatibility standard for UMTS air interfaces and which standards are hereby incorporated herein in their entirety. The standards specify wireless telecommunications system operating protocols, including radio system parameters and call processing procedures. However, those who are of ordinary skill in the art realize that communication system 100 may operate in accordance with any wireless telecommunication system, such as but not limited to a General Packet Radio Service (GPRS) communication system, a Code Division Multiple Access (CDMA) 2000 communication system, a Time Division Multiple Access (TDMA) communication system, or an Orthogonal Frequency Division Multiple Access (OFDM) communication system.

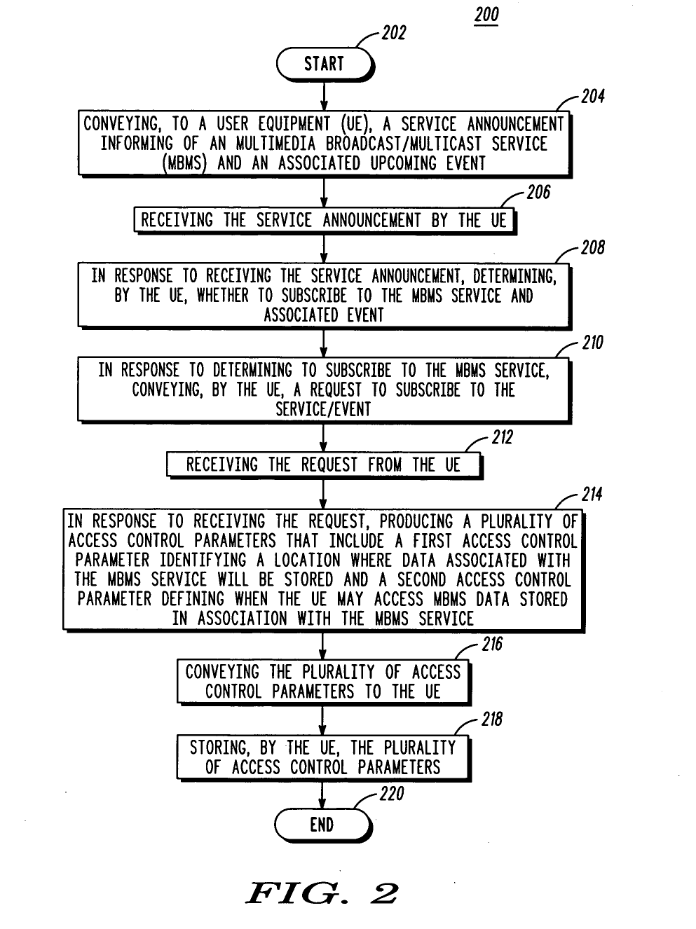

In order for communication system 100 to inform a UE subscribed to the MBMS service of a storage location of MBMS data associated with the service, and to control access to stored MBMS data, communication system 100 distributes the multiple access parameters to UEs when the UEs subscribe to the MBMS service. Referring now to FIG. 2, a logic flow diagram 200 is depicted that illustrates a method by which communication system 100 produces and distributes the multiple access parameters in accordance with an embodiment of the present invention. Logic flow diagram 200 begins (202) when communication system 100, and in particular server 122, conveys (204) a service announcement concerning an MBMS service, such as a broadcast of a sporting event such as a Super Bowl game or a World Cup soccer game, to each UE, such as UE 102, serviced by the communication system. The service announcement comprises information concerning the event, which information may be used by a user of a LE to determine whether to subscribe to the event. For example, the information concerning the event may includes a routing address, such as an Internet Protocol (IP) address, associated with the MBMS content provider 136 sourcing the data related to the event, a subject category, such as “sports” and/or more specifically “soccer” when the event is a soccer game, an event title, such “World Cup Game No. 1,” and a date and a time of the event.

In response to receiving (206) the service announcement, UE 102 determines (208) whether to subscribe to the MBMS service identified in the service announcement. When the UE, that is, UE 102, determines to subscribe to the service, the UE conveys (210) to infrastructure 132, and in particular to support node 116 via RAN 110, a request to subscribe to the MBMS service. The subscription request includes an identifier associated with the MBMS service and the routing address of the server associated with the MBMS service. When UE 102 determines to not subscribe to the service, the MS may not respond to the announcement, other than, perhaps, to acknowledge receipt of the announcement. Included in the request to subscribe is the mobile ID uniquely associated with the UE, allowing support node 116 to determine the source of the response.

In response to receiving (212) the subscription request, infrastructure 132 produces (214) multiple access control parameters for UE 102 to use in determining when the UE may access infrastructure 132 to retrieve missing or erroneously received MBMS data. The multiple access control parameters include a first access control parameter that identifies a storage location of the MBMS data and a second access control parameter that defines when a UE subscribed to the MBMS service, such as UE 102, may access the stored data. Infrastructure 132 then conveys (216) the multiple access control parameters to the UE 102 via air interface 109. In response to receiving the multiple access control parameters, UE 102 stores (218) the multiple access control parameters in the at least one memory device 106 of the UE. Logic flow 200 then ends (220).

In one embodiment of the present invention, the multiple access control parameters may be produced by server 122. That is, when support node 116 receives a request to subscribe to the MBMS service, the support node conveys a request to participate in the MBMS service to server 122. The request may inform of a desire of support node 116 to participate in the MBMS service, a desire of UE 102 to subscribe to the MBMS service, or the UE's desire to subscribe to, and the support node's desire to participate in, the MBMS service. The request may include an identifier associated with the MBMS service, such as a Service ID associated with the MBMS service and/or a routing address associated with MBMS application server 122, and a support node identifier that identifies the support node submitting the request, such as a routing address of support node 116. The request may further include a mobile ID associated with subscribing UE 102.

In response to receiving the request to participate in the MBMS service, server 122 then produces the multiple access control parameters. In one embodiment of the present invention, server 122 may produce the multiple access control parameters by obtaining a storage location identifier and either an ATW parameter or one or more UEAST parameters via an operator network management tool. Server 122 may further store the obtained parameters in at least one memory device 126 for use with respect to subsequently subscribing UEs. In another embodiment of the present invention, when access control parameters are already maintained in at least one memory device 126, server 122 may produce the multiple access control parameters by retrieving a storage location identifier and either an ATW parameter or a UEAST parameter from the at least one memory device. In yet another embodiment of the present invention, when access control parameters are already maintained in at least one memory device 126, server 122 may retrieve a storage location identifier from the at least one memory device and may generate an access start time (UEAST) parameter for the subscribing UE based on the at least one access start time (UEAST) parameter maintained in the at least one memory device. For example, the UEAST parameter maintained in the at least one memory device may be a base, or earliest, UEAST parameter based on which each subscribing UE's UEAST parameter may be generated by the server. Server 122 then conveys the multiple access control parameters to the subscribing UE via support node 116, which support node may or may not store the parameters.

In another embodiment of the present invention, after a first UE has subscribed to the MBMS service via support node 116, the multiple access control parameters for each subsequently subscribing UE may be produced by support node 116. For example, when a first, in time, UE requests to subscribe to the MBMS service via support node 116, MBMS application server 122 produces the multiple access control parameters and conveys the multiple access control parameters to the UE via the support node as described above, except that when a UEAST parameter is to be used by each subscribing UE to determine when to access the stored MBMS data, server 122 may convey multiple UEAST parameters to support node 116. When support node 116 receives the access control parameters from the server, the support node stores, in at least one memory device 120, the access control parameters in association with a Service ID and/or a Temporary Mobile Group Identity (TMGI) associated with the MBMS service. Support node 116 further conveys the storage location identifier and either the ATW parameter or one of the multiple UEAST parameters to the first UE. When another, second UE serviced by support node 116 subsequently requests to subscribe to the MBMS service, support node 116 may then locally produce the multiple access control parameters by retrieving the stored storage location identifier and either the stored ATW parameter or a different UEAST parameter of the multiple stored UEAST parameters from at least one memory device 120. Support node 116 then conveys the retrieved access control parameters to the second UE.

The multiple access control parameters may be conveyed to UE 102 via any cell broadcast format, such as via a paging message over a paging channel, via a short message service (SMS) message, or via a multicast message. In the multicast message scenario, support node 116 may convey the multiple access control parameters to MS 102 in a modified version of an Activate MBMS Context Accept message. Activate MBMS Context Accept messages are known in the art and are described in 3GPP TR 23.846, TS 23.246, and TR 29.846. In such an embodiment of the present invention, the Activate MBMS Context Accept message is modified to include multiple access control parameters data fields in which are embedded the multiple access control parameters. By way of another example, support node 116 may embed the multiple access control parameters in any type of confirmation message conveyed to UE 102 in order to confirm that the UE has successful subscribed to the MBMS service.

When support node 116 includes a GGSN coupled to server 122 and an SGSN coupled to the GGSN and further to RAN 110, then the step of conveying the multiple access control parameters to the responding UE 102 via support node 116 includes a step of conveying the multiple access control parameters from the GGSN to the SGSN. For example, the multiple access control parameters may be conveyed from the GGSN to the SGSN via a modified version of a Create MBMS Context Response message. Create MBMS Context Response messages are known in the art and are described in 3GPP TS 23.246, which message is modified to include one or more access control parameter data fields in which are embedded the multiple access control parameters.

Upon activation of the MBMS service, MBMS content provider 136 conveys MBMS data in one or more communication sessions to subscribed UE 102. For example, the MBMS data may be conveyed via data network 134 or via an operator agreed direct connection (not shown) to server 122 and then via support node 116 and RAN 110 to UE 102. When server 122 receives the MBMS data, the server stores the MBMS data, in association with the Service ID and/or TMGI associated with the MBMS service, in the one or more memory devices 126 of the server and at a location at least partially identified by the first access control parameter.

When UE 102 determines, after the MBMS service activates, that the UE has failed to receive, or has erroneously received, one or more data packets related to the MBMS service, the UE may then access infrastructure 132 and the stored MBMS data by determining an access time based on the multiple access time parameters. For example, the UE may determine that it has erroneously received one or more data packets related to the MBMS service based on one or more frames of received MBMS data have an unacceptably high frame error rate (FER) or bit error rate (BER). By way of another example, the UE may determine that it has failed to receive one or more data packets related to the MBMS service based on a gap in Session Identifiers (Session IDs) or Sequence Identifiers (Sequence IDs) associated with the packets of MBMS data received by the UE.

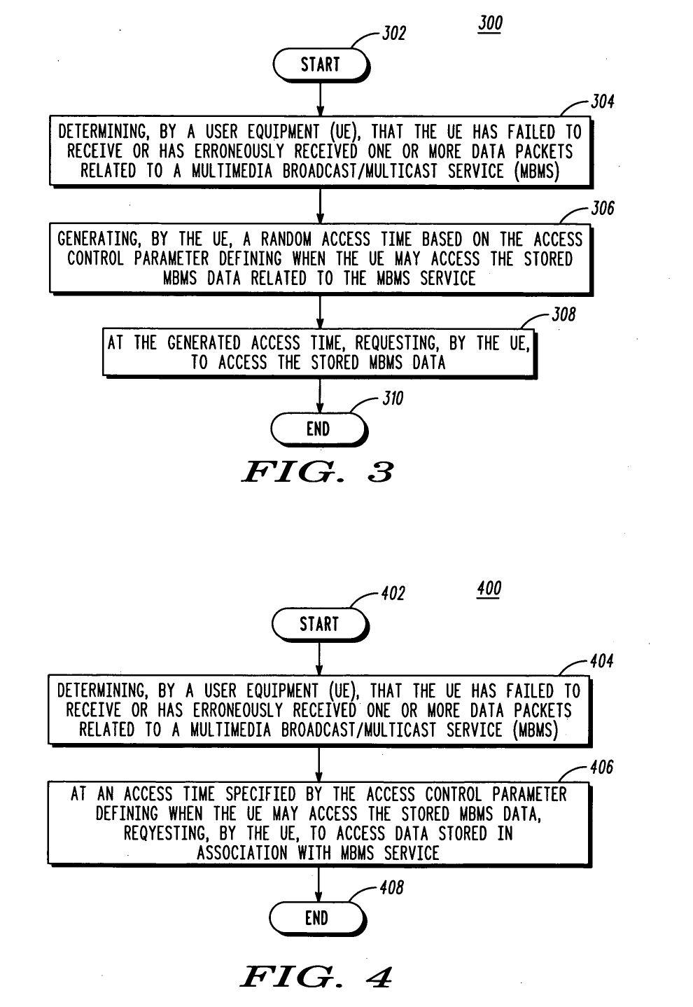

In one embodiment of the present invention, in response to determining that the UE has failed to receive, or has erroneously received, one or more data packets related to the MBMS service, UE 102 may determine when to access infrastructure 132 based on the access time window (ATW) parameter. By utilizing the ATW parameter, which identifies an expiration of a time period, or window, during which UE 102 may access the stored data, communication system 100 provides for distributed access control, wherein control of when the UE may access the storage location is distributed among server 122 and UE 102. Referring now to FIG. 3, a logic flow diagram 300 is depicted that illustrates a method by which UE 102 determines when to access infrastructure 132 to retrieve missing or erroneously received MBMS data based on the ATW parameter. Logic flow diagram 300 begins (302) when UE 102 determines (304) that the UE has failed to receive, or has erroneously received, one or more data packets related to the MBMS service. For example, the UE may determine that one or more frames of received data have an unacceptably high frame error rate (FER) or bit error rate (BER). By way of another example, the UE may determine, based on a Session Identifier (Session ID) or a Sequence Identifier (Sequence ID) associated with each packet of MBMS data received by the UE, that the UE has failed to receive one or more data packets.

In response to determining that it has failed to receive, or has erroneously received, one or more data packets, and based on the stored access time window (ATW) parameter that identifies an expiration of a time period, or window, during which UE 102 may access the stored data, the UE then generates (306) a random access time that is prior to the expiration time, that is, the expiration of the time period, identified by the ATW parameter. At the randomly generated access time, UE 102 then requests (308) to access the stored MBMS data. For example, UE 102 may convey an access request to infrastructure 132 that requests to establish a connection with the infrastructure, and in particular with the storage location of the MBMS data based on the storage location identifier. Logic flow 300 then ends (310). By utilizing the ATW parameter that identifies an expiration of a time period, or window, during which UE 102 may access the stored data, communication system 100 provides a system of access control wherein control of when the UE may access the storage location is distributed among server 122 and UE 102.

In another embodiment of the present invention, in response to determining that the UE has failed to receive, or has erroneously received, one or more data packets related to the MBMS service, UE 102 may determine when to access infrastructure 132 based on the access start time parameter (UEAST) parameter. By utilizing the UEAST parameter, server 122 may retain full control over the access time and UE 102 need not self-generate any random parameters. Referring now to FIG. 4, a logic flow diagram 400 is depicted that illustrates a method by which UE 102 determines when to access infrastructure 132 to retrieve missing or erroneously received MBMS data based on the UEAST parameter. Similar to logic flow diagram 300, logic flow diagram 400 begins (402) when UE 102 determines (404) that the UE has failed to receive, or has erroneously received, one or more data packets related to the MBMS service. In response to determining that it has failed to receive, or has erroneously received, one or more data packets, at the access time specified by the access start time parameter (UEAST), UE 102 requests (406) to access the stored MBMS data. Again, for example, UE 102 may convey an access request to infrastructure 132 that requests to establish a connection with the infrastructure, and in particular with the storage location of the MBMS data based on the storage location identifier. Logic flow 400 then ends (408). By utilizing the UEAST parameter, server 122 may retain full control over the access time and UE 102 need not self-generate any random parameters as are generated by the UE when it uses the ATW parameter.

By conveying a UEAST parameter or an ATW parameter to each UE subscribing to an MBMS service, communication system 100 is able to control access to MBMS data stored in association with the service. When UEAST parameters are provided to the UEs, communication system 100 is able to minimize the congestion that may result when multiple UEs each attempt to access the system to retrieve missing or erroneously received MBMS data by staggering the UEAST parameters provided to the UEs. When ATW parameters are provided to the UEs, the congestion is minimized due to each UE randomly determining an access time based on the provided ATW parameter. Communication system 100 further provides a storage location identifier to each UE subscribing to an MBMS service so that the UE will know how to locate the missing or erroneously received MBMS data.

While the present invention has been particularly shown and described with reference to particular embodiments thereof, it will be understood by those skilled in the art that various changes may be made and equivalents substituted for elements thereof without departing from the scope of the invention as set forth in the claims below. Accordingly, the specification and figures are to be regarded in an illustrative rather then a restrictive sense, and all such changes and substitutions are intended to be included within the scope of the present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any variation thereof, are intended to cover a non-exclusive inclusion, such that a process, method, article, or apparatus that comprises a list of elements does not include only those elements but may include other elements not expressly listed or inherent to such process, method, article, or apparatus. Furthermore, unless otherwise indicated herein, the use of relational terms, if any, such as first and second, top and bottom, and the like are used solely to distinguish one entity or action from another entity or action without necessarily requiring or implying any actual such relationship or order between such entities or actions.

1. A method for generating and distributing access control parameters to a Multimedia Broadcast/Multicast Service (MBMS) communication session, the method comprising:
receiving a request to participate in an MBMS service;
in response to receiving the request, producing a plurality of access control parameters comprising a first access control parameter that identifies a storage location of MBMS data and a second access control parameter that defines when a user equipment may access the stored MBMS data; and
conveying the plurality of access control parameters to a source of the received request.

2. The method of claim 1, further comprising providing a Multimedia Broadcast/Multicast Service (MBMS) applications server and wherein receiving, producing, and conveying are all performed by the server.

3. The method of claim 1, wherein the second access control parameter comprises an access time window parameter that identifies an expiration of a time period during which a subscriber to the Multimedia Broadcast/Multicast Service (MBMS) service may attempt to access the stored MBMS data.

4. The method of claim 1, wherein the second access control parameter comprises an access start time parameter that identifies a time at which a subscriber to the Multimedia Broadcast/Multicast Service (MBMS) service may attempt to access the stored MBMS data.

5. The method of claim 1, wherein receiving a request to participate in a Multimedia Broadcast/Multicast Service (MBMS) service comprises:
receiving, by a support node, a request of a user equipment to subscribe to the MBMS service;
in response to receiving the request, conveying, by the support node to an MBMS application server, the request to participate in the MBMS service;
in response to conveying the request to participate in the Multimedia Broadcast/Multicast Service (MBMS) service, receiving, by the support node from the MBMS application server, the plurality of access control parameters, and wherein conveying further comprises forwarding, by the support node to the user equipment, the received plurality of access control parameters.

6. The method of claim 5, further comprising:
storing, by the support node, the received plurality of access control parameters.
subsequent to storing the plurality of access control parameters, receiving, by the support node, another request to subscribe to the Multimedia Broadcast/Multicast Service (MBMS) service;
in response to receiving the another request to subscribe to the MBMS service, retrieving, by the support node, at least a portion of the plurality of access control parameters stored by the support node; and
conveying, by the support node to a source of the another request, at least one access control parameter based on the retrieved at least a portion of the plurality of access control parameters.

7. The method of claim 1, further comprising:
receiving, by a user equipment, the plurality of access control parameters; and
storing, by the user equipment, the received plurality of access control parameters.

8. The method of claim 7, further comprising:
determining, by the user equipment, at least one of that Multimedia Broadcast/Multicast Service (MBMS) data is missing or that received MBMS data has been erroneously received; and
determining an access time for attempting to access the stored MBMS data based on the received plurality of access control parameters.

9. A method for accessing Multimedia Broadcast/Multicast Service (MBMS) data stored in association with an MBMS service comprising:
storing a first access control parameter that identifies a storage location of the MBMS data;
storing a second access control parameter that defines when a subscriber to the MBMS service may attempt to access the stored MBMS data;
determining at least one of that Multimedia Broadcast/Multicast Service (MBMS) data is missing or that received MBMS data has been erroneously received; and
determining an access time for attempting to access the stored MBMS data based on the received second access control parameter.

10. The method of claim 9, wherein the second access control parameter comprises an access start time parameter that identifies a time at which a subscriber to the Multimedia Broadcast/Multicast Service (MBMS) service may attempt to access the stored MBMS data.

11. The method of claim 9, wherein the second access control parameter comprises an access time window parameter that identifies an expiration of a time period during which a subscriber to the Multimedia Broadcast/Multicast Service (MBMS) service may attempt to access the stored MBMS data and wherein determining an access time comprises randomly generating an access time that occurs prior to the expiration time identified by the second access control parameter.

12. The method of claim 9, further comprising requesting to access the stored MBMS data at the determined access time.

13. A Multimedia Broadcast/Multicast Service (MBMS) application server comprising a processor that receives a request to participate in an MBMS service, in response to receiving the request, produces a plurality of access control parameters comprising a first access control parameter that identifies a storage location of MBMS data associated with an MBMS service and a second access control parameter that defines when a subscriber to the MBMS service may attempt to access the stored MBMS data, and conveys the plurality of access control parameters to a source of the received request.

14. The Multimedia Broadcast/Multicast Service (MBMS) application server of claim 13, wherein the second access control parameter comprises an access time window parameter that identifies an expiration of a time period during which a subscriber to the MBMS service may attempt to access the stored MBMS data.

15. The Multimedia Broadcast/Multicast Service (MBMS) application server of claim 13, wherein the second access control parameter comprises an access start time parameter that identifies a time at which a subscriber to the MBMS service may attempt to access the stored MBMS data.

16. The Multimedia Broadcast/Multicast Service (MBMS) application server of claim 13, wherein the processor produces a plurality of access control parameters by obtaining the plurality of access control parameters via a operator network management tool.

17. The Multimedia Broadcast/Multicast Service (MBMS) application server of claim 13, further comprising at least one memory device operably coupled to the processor that maintains the first access control parameter and the second access control parameter.

18. The Multimedia Broadcast/Multicast Service (MBMS) application server of claim 17, wherein the processor produces the second access control parameter by retrieving, from the at least one memory device, a time at which subscribers to the MBMS service may attempt to access the stored MBMS data, and, based on the retrieved time, generating a time at which an individual subscriber to the MBMS service may attempt to access the stored MBMS data.

19. A user equipment comprising:
at least one memory device; and
a processor operably coupled to the at least one memory device that receives a first access control parameter that identifies a storage location of Multimedia Broadcast/Multicast Service (MBMS) data associated with an MBMS service and a second access control parameter that defines when a subscriber to the MBMS service may attempt to access the stored MBMS data, stores the first access control parameter and the second access control parameter in the at least one memory device, determines at least one of that Multimedia Broadcast/Multicast Service (MBMS) data is missing or that received MBMS data has been erroneously received, and determines an access time for attempting to access the stored MBMS data based on the received second access control parameter.

20. The user equipment of claim 19, wherein the second access control parameter comprises an access start time parameter that identifies a time at which a subscriber to the Multimedia Broadcast/Multicast Service (MBMS) service may attempt to access the stored MBMS data.

21. The user equipment of claim 19, wherein the second access control parameter comprises an access time window parameter that identifies an expiration of a time period during which a subscriber to the Multimedia Broadcast/Multicast Service (MBMS) service may attempt to access the stored MBMS data and wherein the processor determines when to access the storage location of the MBMS data by randomly generating an access time that occurs prior to the expiration time identified by the second access control parameter.

22. The user equipment of claim 19, wherein the processor further requests to access the stored Multimedia Broadcast/Multicast Service data at the determined access time.
